(19) United States
(12) Patent Application Publication
(10) Pub. No.: US 2025/0315956 A1
(43) Pub. Date: Oct. 9, 2025

(54) METHOD FOR SEGMENTING IMAGE SEQUENCE, ELECTRONIC DEVICE AND STORAGE MEDIUM

(71) Applicant: Beijing Baidu Netcom Science Technology Co., Ltd., Beijing (CN)

(72) Inventors: Haotian PENG, Beijing (CN); Feixiang LU, Beijing (CN); Yihao LV, Beijing (CN); Longteng LI, Beijing (CN); He JIANG, Beijing (CN)

(73) Assignee: Beijing Baidu Netcom Science Technology Co., Ltd., Beijing (CN)

(21) Appl. No.: 19/245,074

(22) Filed: Jun. 20, 2025

(30) Foreign Application Priority Data
Dec. 5, 2024 (CN) 202411786530.3

(51) Int. Cl. G06T 7/10; G06T 7/215; G06T 7/246

(52) U.S. Cl. CPC G06T 7/10; G06T 7/215; G06T 7/248

(57) ABSTRACT

A method for segmenting an image sequence is provided. In the method, a motion state of a target object in images is determined to obtain a motion state sequence based on the images in the image sequence; a target motion state among the multiple motion states within a sliding window of the motion state sequence is updated to obtain an updated motion state complying with a kinematics rule of the target object; a segmentation point corresponding to a motion process of the target object in the image sequence is determined based on the updated motion state; and the image sequence is segmented according to the segmentation point.

### CROSS-REFERENCE TO RELATED APPLICATIONS

This application claims the priority from Chinese Patent Application No.202411786530.3, filed on Dec. 5, 2024, the entire disclosure of which is hereby incorporated by reference.

### TECHNICAL FIELD

The present disclosure relates to the technical field of artificial intelligence such as deep learning and large models, and more particularly, to an image sequence segmentation method, an electronic device, and a storage medium, which may be applied to a scenario such as smart sports.

### BACKGROUND

In today's professional sports field, there is an increasing demand for high-precision, real-time performance analysis. This need arises from the continuous pursuit of performance optimization for athletes, including accurate analysis of technical details, immediate adjustment of sports strategies, and effective management of injury prevention. Traditional analysis methods often rely on artificial observation of motion video and artificial post-data processing.

### SUMMARY

The present disclosure provides a segmentation method, apparatus, electronic device, storage medium, and computer program product for an image sequence.

According to a first aspect of the present disclosure, there is provided a method for segmenting an image sequence, including: determining a motion state of a target object in an image sequence based on images in the image sequence to obtain a motion state sequence; updating a target motion state in a plurality of motion states according to the plurality of motion states in the motion state sequence in the sliding window to obtain an updated motion state complying with a kinematics rule of the target object; determining a segmentation point corresponding to a motion process of the target object in the image sequence according to the updated motion state; and segmenting the image sequence according to the segmentation point.

According to a second aspect of the present disclosure, there is provided an electronic device including at least one processor; and a memory in communication with the at least one processor; where the memory stores instructions executable by the at least one processor, the instructions being executed by the at least one processor to cause the at least one processor to perform the method as described in any of the implementations of the first aspect.

According to a third aspect, there is provided a non-transitory computer-readable storage medium storing computer instructions for causing a computer to perform a method as described in any of the implementations of the first aspect.

It should be understood that the content described in this section is not intended to identify key or important features of the embodiments disclosed herein, nor is it intended to limit the scope of the disclosure. The other features disclosed herein will be easily understood through the following description.

### BRIEF DESCRIPTION OF THE DRAWINGS

The drawings are for a better understanding of the present solution and do not constitute a limitation of the present disclosure. Here:

FIG. 1 is an exemplary system architecture diagram to which an embodiment of the present disclosure may be applied;

FIG. 2 is a flowchart of a method for segmenting an image sequence according to an embodiment of the present disclosure;

FIG. 3 is a schematic diagram of image acquisition in trampoline motion according to the present embodiment;

FIG. 4 is a schematic diagram of a specific determination process of an updated motion state according to the present embodiment.

FIG. 5 is a schematic diagram of an application scenario of a method for segmenting an image sequence according to the present embodiment;

FIG. 6 is a schematic diagram of a display interface of a target display apparatus according to the present embodiment;

FIG. 7 is a flowchart of one embodiment of a data recommendation method according to the present disclosure;

FIG. 8 is a block diagram of one embodiment of a segmentation apparatus of an image sequence according to the present disclosure;

FIG. 9 is a schematic structural diagram of a computer system suitable for implementing embodiments of the present disclosure.

### DETAILED DESCRIPTION OF EMBODIMENTS

The following description of exemplary embodiments of the present disclosure, taken in conjunction with the accompanying drawings, includes various details of embodiments of the present disclosure to facilitate understanding, and is to be considered as exemplary only. Accordingly, one of ordinary skill in the art will recognize that various changes and modifications may be made to the embodiments described herein without departing from the scope and spirit of the disclosure. Also, for clarity and conciseness, descriptions of well-known functions and structures are omitted from the following description.

In the technical solution of the present disclosure, the processes of collecting, storing, using, processing, transmitting, providing, and disclosing the user personal information all comply with the provisions of the relevant laws and regulations, and do not violate the public order and good customs.

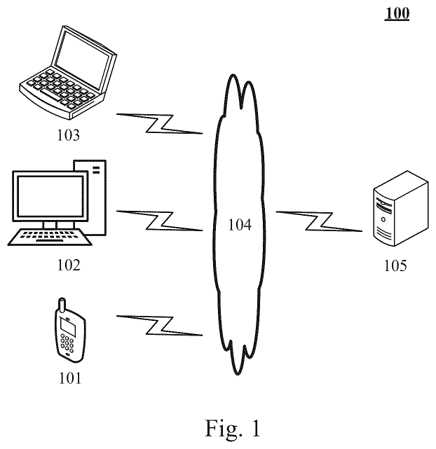

FIG. 1 illustrates an exemplary architecture 100 of a method and an apparatus for segmenting an image sequence to which the present disclosure may be applied.

As shown in FIG. 1, the system architecture 100 may include terminal devices 101, 102, 103, a network 104, and a server 105. The communication connection between the terminal devices 101, 102, 103 constitutes a topology network, and the network 104 serves as a medium for providing a communication link between the terminal devices 101, 102, 103 and the server 105. Network 104 may include various types of connections, such as wired, wireless communication links, or fiber optic cables, among others.

The terminal devices 101, 102, 103 may be hardware devices or software that support network connections for data interaction and data processing. When the terminal devices 101, 102, 103 are hardware, they may be various electronic devices supporting functions of network connection, information acquisition, interaction, display, processing, and the like, including but not limited to a smartphone, a tablet computer, an electronic book reader, a laptop portable computer, a desktop computer, and the like. When the terminal devices 101, 102, and 103 are software, they may be installed in the electronic devices listed above. It may be implemented, for example, as a plurality of software pieces or software modules for providing distributed services, or as a single software piece or software module, which is not specifically limited herein.

Server 105 may be a server that provides various services, for example, a background processing server that determines a segmentation point for an image sequence provided by terminal devices 101, 102, and 103 to segment the image sequence. Optionally, the server may feedback the segmented sequence obtained by segmenting the image sequence to the terminal devices. As an example, server 105 may be a cloud server.

It should be noted that the server may be hardware or software. When the server is hardware, a distributed server cluster composed of multiple servers may be implemented, or a single server may be implemented. When the server is software, it may be implemented as a plurality of software pieces or software modules (e.g., software or software modules used to provide distributed services) or as a single software piece or software module, which is not specifically limited herein.

It should also be noted that the method for segmenting the image sequence provided in the embodiments of the present disclosure is generally performed by a server, but may be performed by a terminal device, or performed by a server and a terminal device in cooperation with each other. Accordingly, each part (for example, each unit) included in the apparatus for segmenting the image sequence may be entirely arranged in the server, may be entirely arranged in the terminal device, or may be separately arranged in the server and the terminal device.

It should be understood that the number of terminal devices, networks and servers in FIG. 1 is merely illustrative. There may be any number of terminal devices, networks, and servers as desired for implementation. When the electronic device on which the method for segmenting the image sequence is performed does not require data transmission with other electronic devices, the system architecture may include only the electronic device on which the method for segmenting the image sequence is performed, such as a terminal device or a server.

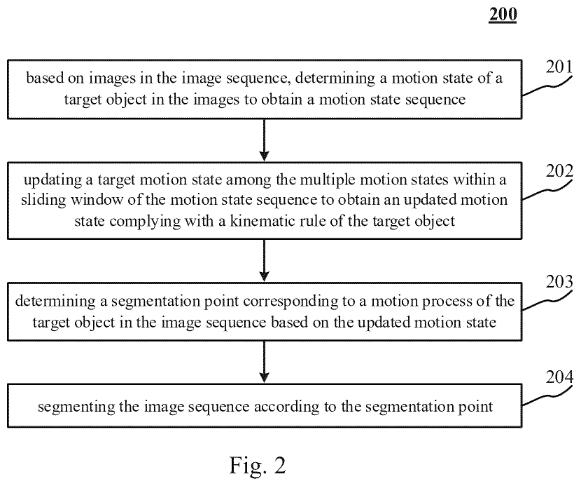

Referring to FIG. 2, FIG. 2 is a flowchart of a method for segmenting an image sequence according to an embodiment of the present disclosure. The flow 200 includes following steps. The method is performed by a hardware processor, a computer, or an electronic device as shown in FIG. 9.

Step 201 includes: based on images in the image sequence, determining a motion state of a target object in the images to obtain a motion state sequence.

In this embodiment, the execution body of the image sequence segmentation method (for example, the server in FIG. 1) may acquire the image sequence remotely or locally through a wired network connection mode or a wireless network connection mode, and determine the motion state of the target object in the images based on the images in the image sequence to obtain the motion state sequence.

The image sequence is an original video obtained by recording a motion process of a target object under authorization of the target object, or a processed video obtained by performing specific processing (for example, enhancing definition, screening key frames, and the like) based on the original video. The target object thereof may be an object having a motion process, such as an athlete, or various sports instruments operated by the athlete.

As an example, the execution body may input the images in the image sequence individually or in batches into the motion state determination model, determine the motion state of the target object in each image in the image sequence through the motion state determination model, and combine the motion states of the target object in each image according to the timing relationship characterized by the image sequence to obtain the motion state sequence. The motion state determination model is used to represent a corresponding relationship between a motion state of an image and a target object in the image, which for example is a convolutional neural network, a circular neural network, a large-line visual language model, and the like.

As yet another example, for each image in the image sequence, the execution body may determine the feature information (e.g., facial feature, limb feature) of the target object in the image, and further determine the motion state of the target object in the image based on the similarity between the feature information and the standard feature information of each motion state.

The target object has different motion states corresponding to different types of motion items. For example, in a trampoline, a pole jump, a high jump, and the like, a motion state includes an ascending state and a descending state; in ball sports such as football and basketball, a sports state includes a ball holding (contact ball) state and a ball not holding (non-contact ball) state.

In some alternative implementations of the present embodiment, the images in the image sequence are depth images. Depth Image, also referred to as a range image, refers to an image in which distances (depths) from an image acquisition device (such as a camera or a depth sensor) to points in a scene are taken as pixel values.

In the present embodiment, the execution body may execute the step 201 as follows.

First, a target depth image corresponding to a moving range of a target object is determined from the depth image.

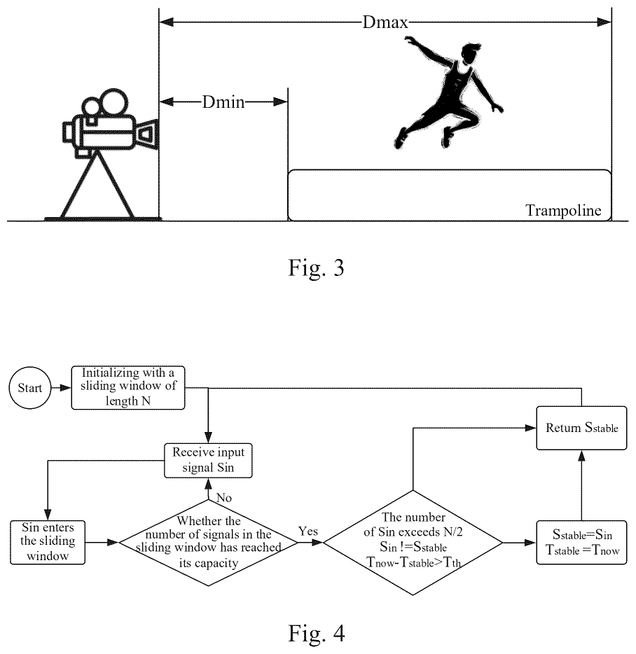

In this implementation, the upper depth threshold Dₘₐₓ and the lower depth threshold Dₘᵢₙ are determined in advance based on the actual conditions of the scene. Subsequently, pixels in the depth image whose pixel values fall between the lower threshold Dₘᵢₙ and the upper threshold Dₘₐₓ are identified, resulting in a target depth image corresponding to the motion range of the target object. Referring again to FIG. 3, which illustrates an image acquisition diagram for trampoline sports, in trampoline sports, the motion process of the athlete takes place entirely on the trampoline, meaning that their motion range is confined to the area corresponding to the trampoline. Therefore, the distance between the image acquisition device and the near end of the trampoline (the end closer to the image acquisition device) may be set as the lower threshold Dₘᵢₙ, while the distance between the image acquisition device and the far end of the trampoline (the end farther from the image acquisition device) may be set as the upper threshold Dₘₐₓ.

Then, a detection box corresponding to the target object is determined from the target depth image.

The detection box is a minimum bounding box corresponding to the target object. The execution body may binarize the target depth image to determine the detection frame corresponding to the target object.

Finally, the motion state of the target object is determined based on the relative positional relationship between the detection frame of the target depth image and the detection frame corresponding to the previous frame of image.

As an example, the two-dimensional center coordinate Pos of the target object may be obtained by obtaining the coordinate center of the detection box BBox; and for the two-dimensional center coordinate Posₜ at time T_{now} (corresponding to the target depth image), and the two-dimensional center coordinate Posₜ₋₁ at time T_{now-1}, the displacement is calculated by the following formula:

$$Δ Y = ( {Pos}_{t} - {Pos}_{t - 1} ) \times Y ,$$

where Y denotes a height, and when ΔY>0 the target object is in an ascending state; and when ΔY<0 the target object is in a descending state.

In the present implementation, a specific approach of determining a motion state of a target object in an image is provided, which is closely matched with an acquisition approach, thereby improving the determination efficiency of the motion state.

Step 202 includes: updating a target motion state among the multiple motion states within a sliding window of the motion state sequence to obtain an updated motion state complying with kinematic rule of the target object.

In this embodiment, the execution body may update the target motion state in the multiple motion states based on the multiple motion states in the motion state sequence that are located in the sliding window, so as to obtain the updated motion state complying with the kinematics rule of the target object.

The capacity of the sliding window may be specifically set according to the actual situation, for example, a capacity of 5. The target motion state may be any one of multiple motion states in the sliding window, but the position of the target motion state in different sliding windows is the same, for example, the target motion state of the current sliding window and the target motion state of the previous sliding window are both an intermediate position in the sliding window.

The kinematics rule is summarized by observation and experimentation, describing the regularity of changes in the position of a person or object in space over time. Take trampoline sports as an example. The five motion states in the sliding window are in sequence (ascending state, ascending state, descending state, ascending state, descending state). It can be understood that both the ascending and descending states of the athlete will last for a certain period of time and will not change repeatedly in a very short time. The above five motion states indicate that the motion state of the target object changes repeatedly in an extremely short time, which means that the five motion states in the sliding window include motion states that do not conform to the kinematics rule.

The reason for the motion state not conforming to the kinematics rule is explained: continuing with the example of trampoline sports, the actual motion state change process is generally that the athlete is in an ascending state from the lowest point to the highest point, and in a descending state from the highest point to the lowest point. However, at the highest point, the athlete is relatively stationary (with unchanged height) for a short period of time (e.g., 0.1 second), during which video acquisition equipment typically captures multiple frames. Taking an image acquisition device with a frame rate of 50 as an example, which captures one frame every 0.02 seconds, it will capture 5 frames within 0.1 second. For these 5 frames, when determining the detection box of the target object, detection errors may cause the determined detection box positions not to be completely consistent, thereby causing the athlete to appear to have rising and falling fluctuations at the highest point. Such a situation can also be referred to as short-term fluctuation interference.

As an example, the execution body may determine whether the target motion state among the multiple motion states complies with the kinematics rule based on the multiple motion states in the sliding window, and in response to determining that the target motion state complies with the kinematics rule, the target motion state is taken as the updated motion state; and in response to determining that the target motion state does not comply with the kinematics rule, the target motion state is adjusted to conform to the kinematics rule according to multiple motion states, and the adjusted motion state is obtained.

With the method for segmenting the image sequence, the impact of the short-term fluctuation interference on image recognition can be mitigated. As a result, the target motion state of the object in the image can be more accurately identified. This approach enhances the reliability and precision of motion state detection, particularly in scenarios where short-term fluctuations can introduce significant errors.

As another example, for different sports, the execution body or an electronic device connected to the execution body via communication has preset conditions representing the kinematic rule corresponding to the sport. The execution body may determine the preset conditions corresponding to the sport represented by the image sequence, and then combine the preset conditions with the multiple motion states within the sliding window to determine whether the target motion state conforms to the preset conditions. In response to conformity, the target motion state is taken as the updated motion state; and in response to non-conformity, the target motion state is adjusted according to the multiple motion states to conform to the preset conditions, resulting in the adjusted motion state.

It will be appreciated that as the sliding window moves along the motion sequence, for each sliding window, the updated motion state of the target motion state within that sliding window is obtained, thereby resulting in multiple updated motion states. When these multiple updated motion states are arranged according to the temporal relationship corresponding to the motion state sequence, they can form the updated motion state sequence.

In some alternative implementations of the present embodiment, the execution body may perform the above-described step 202 by the following way.

First, whether the number of motion states identical to the target motion state among the multiple motion states exceeds a predetermined number threshold is determined.

As an example, whether the number of motion states identical to the target motion state among the multiple motion states exceeds a preset number threshold value is used to represent whether the number of motion states identical to the target motion state among the multiple motion states exceeds a half of the multiple motion states.

Then, in response to determining that it does, whether using the target motion state as the updated motion state conforms to the kinematics rule is determined based on the historical updated motion state.

The historical updated motion state is an updated motion state determined based on the motion state in the historical sliding window.

In the present implementation, the execution body may determine the updated motion states corresponding to all historical sliding windows up to the current one or a preset number of historical sliding windows up to the current one, that is, the historical updated motion states, to obtain a sequence of historical updated motion states. Then, based on the sequence of historical updated motion states, whether using the target motion state as the updated motion state conforms to the laws of kinematics is determined.

Continuing with the example of trampoline sports, whether a short-term fluctuation occurs is determined by taking the target motion state as the updated motion state, so as to determine whether the target motion state as the updated motion state complies with the kinematic rule.

Finally, based on the determination result, the target motion state is determined to be the updated motion state.

When it is determined that using the target motion state as the updated motion state complies with the kinematic rule, the updated motion state is used as the target motion state.

In the present embodiment, a specific approach of determining the updated motion state is provided, so that the accuracy of the determined updated motion state is improved.

In some alternative implementations of the present embodiment, the updated motion state includes an ascending state and a descending state corresponding to a jump motion, the kinematics rule is represented by a preset condition, and the preset condition includes following conditions.

The target motion state is different from the updated motion state corresponding to the previous sliding window; and a difference between the acquisition time of the image corresponding to the target motion state and a start time of a last state change process exceeds a preset time difference threshold. The state change process represents a change between adjacent updated motion states.

For a jump motion, moments affected by short-term fluctuation interference are generally the moments when the target object is at the highest or lowest point. At these moments, the actual motion state of the target object generally changes, and the difference between this change and the occurrence time of the previous state change is relatively large.

Taking the highest point as an example, the change from the ascending state to the descending state generally occurs at this time. The occurrence time of this state change, that is, the moment when the target object is at the highest point in the motion process of the object, is generally represented by the capture time of the image corresponding to the highest point and should be separated by a long time (exceeding the preset time difference threshold) from the moment of the change from the ascending state to descending state in a previous trampoline process

The preset time difference threshold value may be specifically set according to actual conditions, and is not limited herein.

In the present implementation, for a jump motion, a preset condition for representing a kinematics rule is provided to help improve efficiency and accuracy in determining whether using the target motion state as the updated motion state complies with the kinematics rule.

In some alternative implementations of the present embodiment, the execution body may further perform the step 202 by determining a given motion state whose number exceeds the preset number threshold among the multiple motion states as the updated motion state, in response to the number of motion states identical to the target motion state in the plurality of motion states not exceeding the preset number threshold.

Taking trampoline sports as an example, the five motion states in the sliding window are in sequence (ascending state, ascending state, descending state, ascending state, descending state). The target motion state is the “descending state” in the middle position, and the number of the target motion state is 2, which does not exceed the preset number threshold. Therefore, the “ascending state,” whose number exceeds the preset number threshold, is used as the updated motion state corresponding to the target motion state.

In the present embodiment, there is provided a method for determining an updated motion state not exceeding a preset number threshold, thereby improving accuracy and determination efficiency of the updated motion state.

In some alternative implementations of the present embodiment, the target motion state is the last motion state of the multiple motion states.

In this embodiment, the execution body may perform the step 202 of updating the last one of the multiple motion states according to the multiple motion states to obtain the updated motion state.

In the present embodiment, with the target motion state being the last motion state among the multiple motion states, the updated motion state may be determined through the approaches for determining the updated motion state as mentioned above.

In the present implementation, the target motion state is the last motion state among multiple motion states, and the updated motion state corresponding to the last motion state among the multiple motion states is determined according to the multiple motion states, thereby contributing to further improving the accuracy of the updated motion state.

In some alternative implementations of the present embodiment, the execution body may further perform the operation of determining that the number of motion states in the sliding window reaches the capacity of the sliding window before performing step 202.

That is, when the number of motion states in the sliding window reaches the capacity of the sliding window, the operation of determining the updated motion state is not performed.

Taking the capacity of the sliding window being 5 as an example, in the initial stage, the first to fifth frames of the image sequence are successively fed into the sliding window, and the executing entity does not perform the above step 202 to obtain the updated motion state until the fifth frame is fed. For the first four frames, the executing body does not perform the above step 202.

In the present embodiment, the operation of determining the updated motion state is performed only when the number of motion states in the sliding window accumulates to the capacity of the sliding window, which helps to further improve the accuracy of the updated motion state.

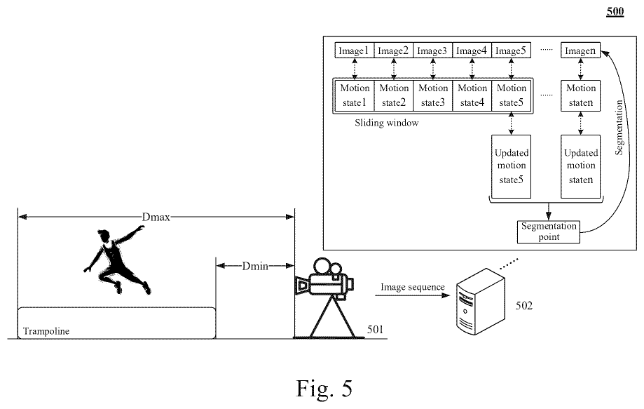

With continued reference to FIG. 4, a schematic diagram of a specific determination process of an updated motion state is shown.

Define the input signal (motion state in the motion state sequence) S_{_in} and the output signal (updated motion state) S_{_out} of the updated motion state determination system as Boolean variables. Boolean variables have only two possibilities: positive and negative, corresponding to the ascending state and descending state, respectively. The sliding window has a length of N, where N is an odd number.
1. Initialization: At the initial stage of motion analysis, the system has no existing states. Whenever an input signal S_{_in} is received, the signal S_{_in} is accumulated into the sliding window. No output signal is generated until N input signals are accumulated. When N frames are accumulated, S_{_stable} is set to the signal that exceeds N/2 in quantity, and the occurrence time T_{_stable} of the state change is set to 0.
2. Main Loop: After accumulating N input signals, the sliding window continues to slide along the motion state sequence. Whenever an input signal S_{_in} is received, the following operations are performed:
2.1. If the number of motion states identical to the signal S_{_in} in the sliding window does not exceed N/2, the system is in an “unstable state,” and the signal S_{_stable} is determined as the updated motion state corresponding to S_{_in}.
2.2 If the number of motion states identical to the signal S_{_in} in the sliding window exceeds N/2, the system is in a “stable state,” and current S_{_stable} is determined. If S_{_in} is not equal to S_{_stable} and a period between the current time T_{_now} and T_{_stable} is greater than the preset time difference threshold T_{_th}, then the signal S_{_stable} is updated to S_{_in}, T_{_stable} is set to T_{_now}, and S_{_in} is used as the updated motion state.

Step 203 includes determining a segmentation point corresponding to a motion process of the target object in the image sequence based on the updated motion state.

In this embodiment, the execution body may update the motion state and determine the segmentation point corresponding to a motion process of the target object in the image sequence. The image sequences generally represents repeated motion processes of the target object, and an image sequence between adjacent segmentation points represent one motion process of the target object.

As an example, the execution body may analyze each updated motion state in the updated motion state sequence, and determine a start time and an end time of one motion process of the target object; and the start time and the end time are taken as segmentation points.

As yet another example, for different sports, the executing body may determine the corresponding segmentation point determination approaches. For instance, for jumping sports, the change moment between the ascending state and the descending state is used as the segmentation point; for ball sports, the change moment between the ball-holding state and the non-ball-holding state is used as the segmentation point. In this way, the executing body may determine the segmentation point corresponding to a motion process of the target object in the image sequence based on the updated motion state sequence and the segmentation point determination approach corresponding to the sport represented by the image sequence.

It should be understood that there is a one-to-one correspondence between the images in the image sequence and the motion states in the motion state sequence; after the number of motion states in the sliding window accumulates to the capacity of the sliding window, there is a one-to-one correspondence between the motion states in the motion state sequence and the updated motion states in the updated motion state sequence.

In some alternative implementations of the present embodiment, the execution body may perform the step 203 by: for an image in the image sequence, determining the segmentation point between the image and a previous frame of image, in response to the updated motion state corresponding to the image being a descending state and the updated motion state corresponding to the previous frame of image being an ascending state.

With continued reference to the implementation corresponding to FIG. 4 above, when this occurs, it is indicated that the jump state changes: Sₜ!=Sₜ₋₁

If S_{_t} is the descending state, the target object is transitioning from the ascending state to the descending state, and at this time, T_{_now} is at the highest point of the jump.

If S_{_t} is the ascending state, the target object is transitioning from the descending state to the ascending state, and at this time, T_{_now} is at the lowest point of the jump, which marks the end of the current jump and the beginning of the next jump.

In the present embodiment, there is provided a segmentation point determination method for a jump motion, which improves accuracy and determination efficiency of a segmentation point determination operation.

Step 204 includes segmenting the image sequence according to the segmentation point.

In this embodiment, the execution body may segment the image sequence according to the segmentation point.

As an example, the execution body segments the image sequence according to the segmentation point to obtain multiple segmented sequences. Each segmented sequence represents a motion process of the target object.

With continued reference to FIG. 5, FIG. 5 is a schematic diagram 500 of an application scenario of a method for segmenting an image sequence according to the present embodiment. The user acquires the image sequence of the trampoline athlete through the video acquisition device 501 and uploads the image sequence to the server 502. The server 502 first determines a motion state of a target object in the image based on the image in the image sequence to obtain a motion state sequence; then, the target motion state in the multiple motion states is updated based on the multiple motion states in the motion state sequence in the sliding window to obtain the updated motion state according to the kinematics rule of the target object; based on the updated motion state, a segmentation point corresponding to one motion process of the target object is determined in the image sequence; and finally the image sequence is segmented according to the segmentation point.

In the present embodiment, an image sequence segmentation method and apparatus are provided, in which a target motion state is updated according to multiple motion states of the motion state sequence in a sliding window, so that the updated motion state complies with a kinematics rule, thereby avoiding interference of a short-time fluctuation in a motion process with the updated motion state, improving accuracy of a segmentation point determined based on the updated motion state, and further improving real-time performance and accuracy of a segmentation process of an image sequence corresponding to the motion state sequence.

In some alternative implementations of the present embodiment, the execution body may further perform operations of first determining the attribute information of the motion process according to the segmented sequence obtained by segmenting the image sequence; and then displaying the segmented sequence and the attribute information by using a target display device.

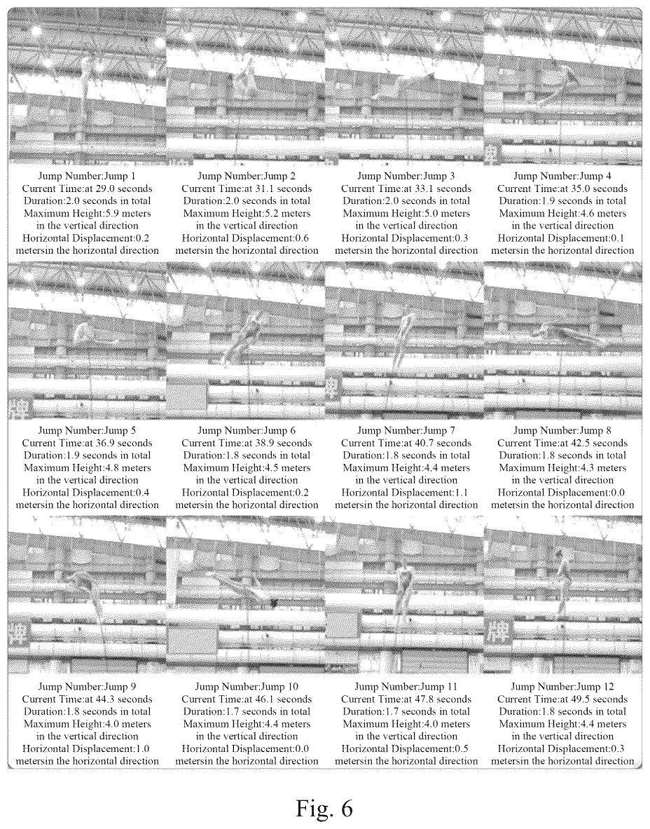

With continued reference to FIG. 6, a schematic diagram of a display interface of a target display device is shown. The target display device may use a key image of each segmented sequence as the representative image to display the attribute information of each motion process. The target display device may be a display screen having a data display function, a smartphone, or the like.

Taking trampoline sports as an example, the attribute information includes, but is not limited to, a duration of the motion process, the maximum height, and the horizontal displacement. The duration represents the length of the motion process and may be determined based on the capture time of the start and end frame images of the segmented sequence. The maximum height represents the highest jump height during a motion process and may be determined based on the detection box of the target object when the target object transitions from an ascending state to a descending state. The horizontal displacement represents the horizontal displacement distance of the target object during a motion process and may be determined based on the detection boxes of the target object in the images.

In the present embodiment, the execution body may determine and display the attribute information of the movement process, which helps to improve the information acquisition efficiency and the experience degree of the user.

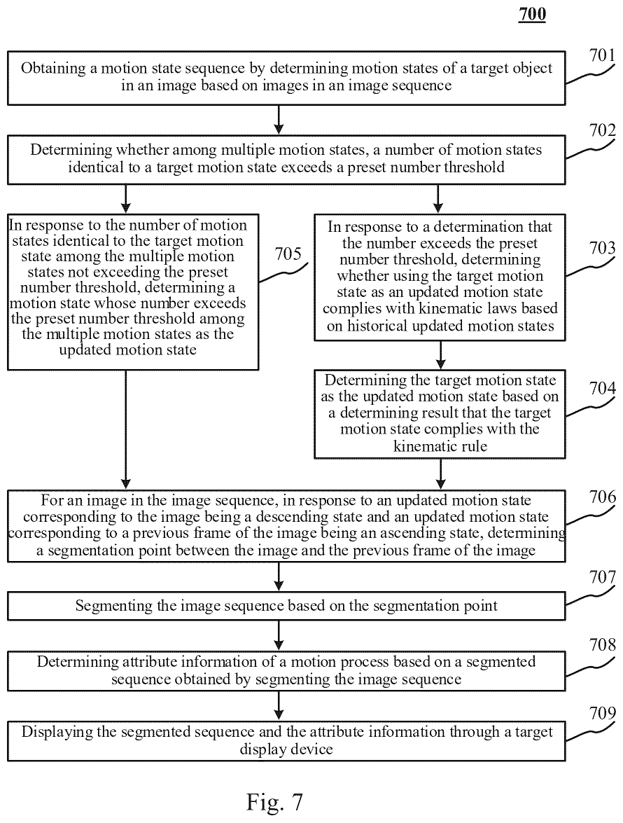

With continued reference to FIG. 7, a schematic flow 700 of a method for segmenting an image sequence according to yet another embodiment of the present disclosure is shown. The flow 700 include following steps.

Step 701 includes obtaining, based on images in an image sequence, a motion state sequence by determining motion states of a target object in the images.

Step 702 includes determining whether among multiple motion states, a number of motion states identical to a target motion state exceeds a preset number threshold

Step 703 includes in response to a determination that the number exceeds the preset number threshold, determining whether using the target motion state as an updated motion state complies with a kinematic rule based on a historical updated motion state.

The historical updated motion state is an updated motion state determined based on the motion state in the historical sliding window; the updated motion state includes an ascending state and a descending state corresponding to a jump motion, and the kinematics rule is represented by a preset condition including that the target motion state is different from the updated motion state corresponding to the previous sliding window, and the difference between the acquisition time of the image corresponding to the target motion state and an occurrence time of a previous state change exceeds a preset time difference threshold, where the state change represents a change between adjacent updated motion states.

Step 704 includes determining the target motion state as the updated motion state based on a determining result that the target motion state complies with the kinematic rule.

Step 705 includes in response to the number of motion states identical to the target motion state among the multiple motion states not exceeding the preset number threshold, determining a motion state whose number exceeds the preset number threshold among the multiple motion states as the updated motion state.

Step 706 includes for an image in the image sequence, in response to an updated motion state corresponding to the image being a descending state and an updated motion state corresponding to a previous frame of the image being an ascending state, determining a segmentation point between the image and the previous frame of the image.

For the image in the image sequence, in response to the updated motion state corresponding to the image being a descending state and the updated motion state corresponding to the previous frame of image being an ascending state, the segmentation point is determined between the image and the previous frame of image.

Step 707 includes segmenting the image sequence based on the segmentation point.

Step 708 includes determining attribute information of a motion process based on a segmented sequence obtained by segmenting the image sequence.

Step 709 includes displaying the segmented sequence and the attribute information through a target display device.

The flow 700 of the method for determining a sequence label in the present embodiment specifically describes a determination process of an updated motion state, a determination process of a segmentation point, and a display process of a segmented sequence and attribute information, so as to prevent the updated motion state from being interfered with by short-time fluctuations in the motion process, improve accuracy of the segmentation point determined based on the updated motion state, and further improve real-time performance and accuracy of the segmentation process of the image sequence corresponding to the motion state sequence.

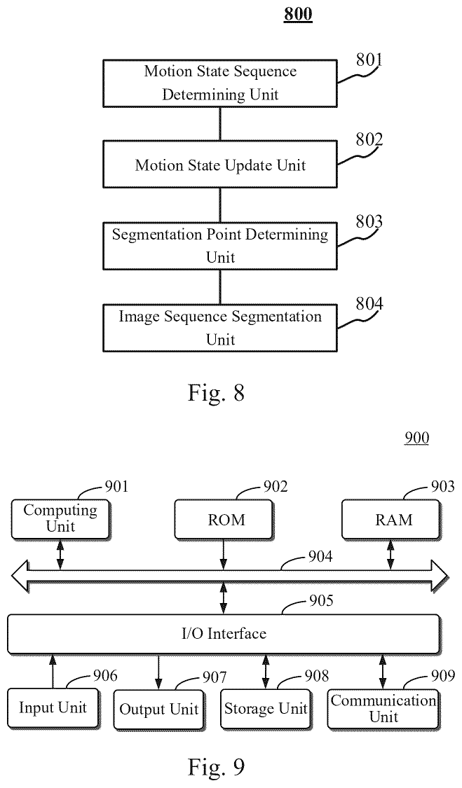

With continued reference to FIG. 8, as an implementation of the method shown in each of the above figures, the present disclosure provides an embodiment of a segmentation apparatus for an image sequence, which corresponds to the method embodiment shown in FIG. 2, and which is particularly applicable to various electronic devices.

As shown in FIG. 8, a segmentation apparatus 800 of an image sequence includes a state sequence determining unit 801 configured to determine motion states of a target object in images based on the images in the image sequence to obtain a motion state sequence; a state updating unit 802 configured to update a target motion state among the multiple motion states according to the multiple motion states in the sliding window in the motion state sequence, so as to obtain an updated motion state according to a kinematics rule of the target object; a segmentation point determining unit 803 configured to determine a segmentation point corresponding to a motion process of a target object in the image sequence according to an updated motion state; and the image sequence segmentation unit 804 is configured to segment the image sequence according to the segmentation points.

In some alternative implementations of the present embodiment, the state updating unit 802 is further configured to determine whether the number of motion states identical to the target motion state among the multiple motion states exceeds a preset number threshold; determine, in response to the positive determination, based on the historical updated motion states, whether using the target motion state as the updated motion state conforms to the kinematic rule, where the historical updated motion state is the updated motion state determined based on the motion states in the historical sliding window; and based on a determination result that using the target motion state as the updated motion state conforms to the kinematic rule, determine the target motion state as the updated motion state.

In some alternative implementations of the present embodiment, the updated motion state includes an ascending state and a descending state corresponding to a jump motion, the kinematics rule is represented by a preset condition, and the preset condition includes that the target motion state is different from the updated motion state corresponding to the previous sliding window; and the difference between the acquisition time of the image corresponding to the target motion state and the occurrence time of the previous state change exceeds a preset time difference threshold, where the state change represents a change between adjacent updated motion states.

In some alternative implementations of the present embodiment, the state updating unit 802 is further configured to determine a motion state whose number exceeds the preset number threshold among the multiple motion states as the updated motion state in response to the number of motion states identical to the target motion state in the multiple motion states not exceeding the preset number threshold.

In some alternative implementations of the present embodiment, the segmentation point determining unit 803 is further configured to determine, for an image in the image sequence, the segmentation point between the image and the previous frame of image, in response to the updated motion state corresponding to the image being a descending state and the updated motion state corresponding to the previous frame of image being an ascending state.

In some alternative implementations of the present embodiment, the target motion state is the last motion state of the multiple motion states; and the state updating unit 802 is further configured to update the last one of the multiple motion states according to the multiple motion states to obtain the updated motion state.

In some alternative implementations of the present embodiment, the apparatus further comprises a full-load determining unit (not shown) configured to determine that the number of motion states in the sliding window reaches the capacity of the sliding window.

In some alternative implementations of the present embodiment, the image is a depth image, and the state sequence determining unit 801 is further configured to determine a target depth image corresponding to a motion range of the target object from the depth image; determine a detection frame corresponding to the target object from the target depth map; determine the motion state of the target object based on a relative positional relationship between the detection frame of the target depth image and the detection frame corresponding to the previous frame of image.

In some alternative implementations of the present embodiment, the apparatus further includes an attribute determining unit (not shown) configured to determine attribute information of the motion process based on the segmented sequence obtained by segmenting the image sequence; and a display unit (not shown in the figure) configured to display the segmented sequence and attribute information through the target display device.

In the present embodiment, there is provided a segmentation apparatus for an image sequence, in which a target motion state is updated according to multiple motion states of the motion state sequence in a sliding window, so that the updated motion state complies with a kinematics rule, thereby avoiding interference of a short time fluctuation in a motion process with the updated motion state, improving accuracy of the segmentation point determined based on the updated motion state, and further improving real-time performance and accuracy of a segmentation process of an image sequence corresponding to the motion state sequence.

According to an embodiment of the present disclosure, the present disclosure further provides an electronic device including at least one processor; and a memory in communication with the at least one processor; where the memory stores instructions executable by the at least one processor to enable the at least one processor to implement the method for segmenting the image sequence described in any of the above embodiments when executed.

According to an embodiment of the present disclosure, the present disclosure further provides a readable storage medium storing computer instructions for causing a computer to perform the method for segmenting the image sequence described in any of the above embodiments when executed.

Embodiments of the present disclosure provide a computer program product that, when executed by a processor, is capable of implementing the method for segmenting the image sequence described in any of the above embodiments.

FIG. 9 illustrates a schematic block diagram of an example electronic device 900 that may be used to implement embodiments of the present disclosure. Electronic devices are intended to represent various forms of digital computers, such as laptop computers, desktop computers, worktables, personal digital assistants, servers, blade servers, mainframe computers, and other suitable computers. Electronic devices may also represent various forms of mobile devices, such as personal digital processing, cellular telephones, smart phones, wearable devices, and other similar computing devices. The components shown herein, their connections and relationships, and their functions are by way of example only and are not intended to limit the implementation of the disclosure described and/or claimed herein.

As shown in FIG. 9, the device 900 includes a computing unit 901, which may perform various appropriate actions and processes according to a computer program stored in a read-only memory (ROM) 902 or a computer program loaded into a random access memory (RAM) 903 from a storage unit 908. In RAM s903, various programs and data required for operation of the device 900 may also be stored. The computing unit 901, ROM 902 and RAM 903 are connected to each other via a bus 904. An input/output (I/O) interface 905 is also connected to bus 904.

Multiple components in the device 900 are connected to the I/O interface 905, including an input unit 906, such as a keyboard, a mouse, and the like; an output unit 907, for example, various types of displays, speakers, and the like; a storage unit 908, such as a magnetic disk, an optical disk, or the like; and a communication unit 909, such as a network card, a modem, or a wireless communication transceiver. The communication unit 909 allows the device 900 to exchange information/data with other devices over a computer network such as the Internet and/or various telecommunications networks.

The computing unit 901 may be various general-purpose and/or special-purpose processing components having processing and computing capabilities. Some examples of computing units 901 include, but are not limited to, central processing units (CPUs), graphics processing units (GPUs), various specialized artificial intelligence (AI) computing chips, various computing units running machine learning model algorithms, digital signal processors (DSPs), and any suitable processors, controllers, microcontrollers, and the like. The computing unit 901 performs various methods and processes described above, such as a method for segmenting an image sequence. For example, in some embodiments, the method for segmenting the image sequence may be implemented as a computer software program tangibly embodied in a machine-readable medium, such as storage unit 908. In some embodiments, some or all of the computer program may be loaded and/or installed on the device 900 via the ROM 902 and/or the communication unit 909. When the computer program is loaded into the RAM 903 and executed by the computing unit 901, one or more steps of the method for segmenting the image sequence described above may be performed. Alternatively, in other embodiments, the computing unit 901 may be configured to perform the method for segmenting the image sequence by any other suitable means (e.g., by means of firmware).

The various embodiments of the systems and techniques described above herein may be implemented in a digital electronic circuit system, an integrated circuit system, a field programmable gate array (FPGA), an application specific integrated circuit (ASIC), a special purpose standard product (ASSP), a system on a system on a chip (SOC), a load programmable logic device (CPLD), computer hardware, firmware, software, and/or combinations thereof. These various embodiments may include being implemented in one or more computer programs that may execute and/or interpret on a programmable system including at least one programmable processor, which may be a dedicated or general purpose programmable processor, may receive data and instructions from a memory system, at least one input device, and at least one output device, and transmit the data and instructions to the memory system, the at least one input device, and the at least one output device.

The program code for carrying out the methods of the present disclosure may be written in any combination of one or more programming languages. These program codes may be provided to a processor or controller of a general purpose computer, special purpose computer, or other segmentation device of a sequence of programmable images, such that the program code, when executed by the processor or controller, causes the functions/operations specified in the flowchart and/or block diagram to be implemented. The program code may be executed entirely on the machine, partly on the machine, partly on the machine as a stand-alone software package and partly on the remote machine or entirely on the remote machine or server.

In the context of the present disclosure, a machine-readable medium may be a tangible medium that may contain or store a program for use by or in connection with an instruction execution system, apparatus, or device. The machine-readable medium may be a machine-readable signal medium or a machine-readable storage medium. The machine-readable medium may include, but is not limited to, electronic, magnetic, optical, electromagnetic, infrared, or semiconductor systems, devices, or devices, or any suitable combination of the foregoing. More specific examples of machine-readable storage media may include one or more line-based electrical connections, portable computer disks, hard disks, random access memory (RAM), read-only memory (ROM), erasable programmable read-only memory (EPROM or flash memory), optical fibers, portable compact disk read-only memory (CD-ROM), optical storage devices, magnetic storage devices, or any suitable combination of the foregoing.

To provide interaction with a user, the systems and techniques described herein may be implemented on a computer having a display device (e.g., a CRT (cathode ray tube) or LCD (liquid crystal display) monitor) for displaying information to the user; and a keyboard and a pointing device (e.g., a mouse or a trackball) through which a user can provide input to a computer. Other types of devices may also be used to provide interaction with a user; For example, the feedback provided to the user may be any form of sensory feedback (e.g., visual feedback, auditory feedback, or tactile feedback); and input from the user may be received in any form, including acoustic input, speech input, or tactile input.

The systems and techniques described herein may be implemented in a computing system including a background component (e.g., as a data server), or a computing system including a middleware component (e.g., an application server), or a computing system including a front-end component (e.g., a user computer having a graphical user interface or a web browser through which a user may interact with embodiments of the systems and techniques described herein), or a computing system including any combination of such background component, middleware component, or front-end component. The components of the system may be interconnected by any form or medium of digital data communication (e.g., a communication network). Examples of communication networks include a local area network (LAN), a wide area network (WAN), and the Internet.

The computer system may include a client and a server. The client and server are typically remote from each other and typically interact through a communication network. The relationship between the client and the server is generated by a computer program running on the corresponding computer and having a client-server relationship with each other. A server may be a cloud server, also referred to as a cloud computing server or a cloud host, and is a host product in a cloud computing service system, so as to resolve a defect that a conventional physical host and a VPS (Virtual Private Server) service are difficult to manage, and service scalability is weak; It may also be a server of a distributed system or a server incorporating a chain of blocks.

According to the technical solution of the embodiment of the present disclosure there is provided a segmentation method and apparatus for an image sequence, in which a target motion state is updated according to multiple motion states of the motion state sequence in a sliding window, so that the updated motion state complies with a kinematics rule, thereby avoiding interference of the updated motion state by a short time fluctuation in a motion process, improving accuracy of a segmentation point determined based on the updated motion state, and further improving real-time performance and accuracy of a segmentation process of an image sequence corresponding to the motion state sequence.

It is to be understood that the steps of reordering, adding or deleting may be performed using the various forms shown above. For example, the steps described in the present disclosure may be performed in parallel or sequentially or in a different order, so long as the desired results of the technical solution provided in the present disclosure can be realized, and no limitation is imposed herein.

The foregoing detailed description is not intended to limit the scope of the present disclosure. It will be appreciated by those skilled in the art that various modifications, combinations, sub-combinations, and substitutions may be made depending on design requirements and other factors. Any modifications, equivalents, and modifications that fall within the spirit and principles of the disclosure are intended to be included within the scope of protection of the disclosure.

What is claimed is:

1. A method for segmenting an image sequence, comprising:
determining a motion state of a target object in an image sequence based on images in the image sequence to obtain a motion state sequence;
updating a target motion state in a plurality of motion states according to the plurality of motion states in the motion state sequence in the sliding window to obtain an updated motion state complying with a kinematics rule of the target object;
determining a segmentation point corresponding to a motion process of the target object in the image sequence according to the updated motion state; and
segmenting the image sequence according to the segmentation point.

2. The method according to claim 1, wherein the updating the target motion state in the plurality of motion states according to the plurality of motion states in the motion state sequence in the sliding window to obtain the updated motion state complying with the kinematics rule of the target object comprises:
determining whether a number of motion states identical to the target motion state among the plurality of motion states exceeds a preset number threshold;
determining, in response to determining that the number of motion states exceeds the preset number threshold, whether using the target motion state as the updated motion state complies with the kinematics rule based on a historical updated motion state, wherein the historical updated motion state is an updated motion state determined based on a motion state in a historical sliding window; and
determining the target motion state as the updated motion state based on a determining result that using the target motion state as the updated motion state complies with the kinematics rule.

3. The method according to claim 2, wherein the updated motion state comprises an ascending state and a descending state corresponding to a jump motion, the kinematics rule being represented by a preset condition, the preset condition comprising that:
the target motion state is different from the updated motion state corresponding to a previous sliding window; and
a difference between an acquisition time of an image corresponding to the target motion state and an occurrence time of a last state change exceeds a preset time difference threshold, wherein the state change represents a change between adjacent updated motion states.

4. The method according to claim 2, wherein the updating the target motion state of the plurality of motion states according to the plurality of motion states in the sliding window in the sequence of motion states to obtain the updated motion state complying with the kinematics rule of the target object, further comprises:
determining a given motion state whose number exceeds the preset number threshold among the multiple motion states as the updated motion state, in response to the number of motion states identical to the target motion state in the plurality of motion states not exceeding the preset number threshold.

5. The method according to claim 4, wherein the determining the segmentation point corresponding to the motion process of the target object in the image sequence according to the updated motion state comprises:
for an image in the image sequence, in response to an updated motion state corresponding to the image being a descending state and an updated motion state corresponding to a previous frame of the image being an ascending state, determining the segmentation point between the image and the previous frame of the image.

6. The method according to claim 1, wherein the target motion state is a last motion state of the plurality of motion states; and
the updating the target motion state in the plurality of motion states according to the plurality of motion states in the motion state sequence in the sliding window to obtain the updated motion state complying with the kinematics rule of the target object comprises:
updating the last motion state of the plurality of motion states according to the plurality of motion states to obtain the updated motion state.

7. The method according to claim 1, wherein before updating the target motion state of the plurality of motion states according to the plurality of motion states in the sliding window in the sequence of motion states to obtain the updated motion state complying with the kinematic rule of the target object, the method further comprises:
determining that a number of motion states in the sliding window reaches a capacity of the sliding window.

8. The method according to claim 1, wherein the images are depth images, and
the determining the motion state of the target object in the image comprises:
determining a target depth image corresponding to a motion range of the target object from the depth images;
determining a detection frame corresponding to the target object from the target depth image; and
determining the motion state of the target object based on a relative positional relationship between the detection frame of the target depth image and a detection frame corresponding to a previous frame of image.

9. The method according to claim 1, further comprising:
determining attribute information of the motion process according to a segmented sequence obtained by segmenting the image sequence; and
displaying the segmented sequence and the attribute information through a target display device.

10. An electronic device, comprising:
at least one processor; and
a memory in communication with the at least one processor;
wherein the memory stores instructions executable by the at least one processor to cause the at least one processor to perform operations comprising:
determining a motion state of a target object in an image sequence based on images in the image sequence to obtain a motion state sequence;
updating a target motion state in a plurality of motion states according to the plurality of motion states in the motion state sequence in the sliding window to obtain an updated motion state complying with a kinematics rule of the target object;
determining a segmentation point corresponding to a motion process of the target object in the image sequence according to the updated motion state; and
segmenting the image sequence according to the segmentation point.

11. The electronic device according to claim 10, wherein the updating the target motion state in the plurality of motion states according to the plurality of motion states in the motion state sequence in the sliding window to obtain the updated motion state complying with the kinematics rule of the target object comprises:
determining whether a number of motion states identical to the target motion state among the plurality of motion states exceeds a preset number threshold;
determining, in response to determining that the number of motion states exceeds the preset number threshold, whether using the target motion state as the updated motion state complies with the kinematics rule based on a historical updated motion state, wherein the historical updated motion state is an updated motion state determined based on a motion state in a historical sliding window; and
determining the target motion state as the updated motion state based on a determining result that using the target motion state as the updated motion state complies with the kinematics rule.

12. The electronic device according to claim 11, wherein the updated motion state comprises an ascending state and a descending state corresponding to a jump motion, the kinematics rule being represented by a preset condition, the preset condition comprising that:
the target motion state is different from the updated motion state corresponding to a previous sliding window; and
a difference between an acquisition time of an image corresponding to the target motion state and an occurrence time of a last state change exceeds a preset time difference threshold, wherein the state change represents a change between adjacent updated motion states.

13. The electronic device according to claim 11, wherein the updating the target motion state of the plurality of motion states according to the plurality of motion states in the sliding window in the sequence of motion states to obtain the updated motion state complying with the kinematics rule of the target object, further comprises:
determining a given motion state whose number exceeds the preset number threshold among the multiple motion states as the updated motion state, in response to the number of motion states identical to the target motion state in the plurality of motion states not exceeding the preset number threshold.

14. The electronic device according to claim 13, wherein the determining the segmentation point corresponding to the motion process of the target object in the image sequence according to the updated motion state comprises:
for an image in the image sequence, in response to an updated motion state corresponding to the image being a descending state and an updated motion state corresponding to a previous frame of the image being an ascending state, determining the segmentation point between the image and the previous frame of the image.

15. The electronic device according to claim 10, wherein the target motion state is a last motion state of the plurality of motion states; and
the updating the target motion state in the plurality of motion states according to the plurality of motion states in the motion state sequence in the sliding window to obtain the updated motion state complying with the kinematics rule of the target object comprises:
updating the last motion state of the plurality of motion states according to the plurality of motion states to obtain the updated motion state.

16. The electronic device according to claim 10, wherein before updating the target motion state of the plurality of motion states according to the plurality of motion states in the sliding window in the sequence of motion states to obtain the updated motion state complying with the kinematic rule of the target object, the method further comprises:
determining that a number of motion states in the sliding window reaches a capacity of the sliding window.

17. The electronic device according to claim 10, wherein the images are depth images, and
the determining the motion state of the target object in the image comprises:
determining a target depth image corresponding to a motion range of the target object from the depth images;
determining a detection frame corresponding to the target object from the target depth image; and
determining the motion state of the target object based on a relative positional relationship between the detection frame of the target depth image and a detection frame corresponding to a previous frame of image.

18. The electronic device according to claim 10, further comprising:
determining attribute information of the motion process according to a segmented sequence obtained by segmenting the image sequence; and
displaying the segmented sequence and the attribute information through a target display device.

19. A non-transitory computer-readable storage medium storing computer instructions for causing the computer to perform operations comprising:
determining a motion state of a target object in an image sequence based on images in the image sequence to obtain a motion state sequence;
updating a target motion state in a plurality of motion states according to the plurality of motion states in the motion state sequence in the sliding window to obtain an updated motion state complying with a kinematics rule of the target object;
determining a segmentation point corresponding to a motion process of the target object in the image sequence according to the updated motion state; and
segmenting the image sequence according to the segmentation point.

20. The non-transitory computer-readable storage medium according to claim 19, wherein the updating the target motion state in the plurality of motion states according to the plurality of motion states in the motion state sequence in the sliding window to obtain the updated motion state complying with the kinematics rule of the target object comprises:
determining whether a number of motion states identical to the target motion state among the plurality of motion states exceeds a preset number threshold;
determining, in response to determining that the number of motion states exceeds the preset number threshold, whether using the target motion state as the updated motion state complies with the kinematics rule based on a historical updated motion state, wherein the historical updated motion state is an updated motion state determined based on a motion state in a historical sliding window; and
determining the target motion state as the updated motion state based on a determining result that using the target motion state as the updated motion state complies with the kinematics rule.
